(19) United States
(12) Patent Application Publication
(10) Pub. No.: US 2007/0200014 A1
(43) Pub. Date: Aug. 30, 2007

(54) SINK SPRAY HEAD WITH SUPPLY JET VARIATION AND FLOW RATE REGULATION

(76) Inventor: Fabrizio Nobili, San Vittore (CH)

Correspondence Address: SEED INTELLECTUAL PROPERTY LAW GROUP PLLC, 701 FIFTH AVE, SUITE 5400, SEATTLE, WA, 98104, US

(21) Appl. No.: 11/680,450

(22) Filed: Feb. 28, 2007

(30) Foreign Application Priority Data
Feb. 28, 2006 (IT) MI2006A000357

(51) Int. Cl. B05B 1/30

(52) U.S. Cl. 239/569; 239/587.1

(57) ABSTRACT

A sink spray head with supply variation and flow rate regulation, comprising a body defining at least two distinct water supply areas in communication with a distribution chamber controlled by a diverting cut-off driven by selection means accessible outside the body, a cut-off being also provided for the regulation of the water flow rate. The selection means comprise an up-and-over button.

### BACKGROUND OF THE INVENTION

1. Field of the Invention

The present invention relates to a sink spray head with supply jet variation and flow rate regulation.

2. Prior Description of the Related Art

As it is known, at present, sink spray heads on sale can be both of the “pulldown” type, i.e., associated with the tap pipe, or of the “pullout” type, i.e., withdrawable from the sink, and are structured in such a way as to execute the supply jet variation.

These spray heads are typically provided with two distinct, flanked keys which can be selectively activated so as to obtain an aerated central jet or, possibly, an indiscriminate peripheral jet.

These spray heads then show a further key or button which gives the possibility to regulate the water flow rate.

These spray heads are thus provided with two sliding keys which are used to execute the variation of the supply jet type, which are structurally very complex and such as not to allow an easy use by the user that must execute the passage from a key to the other to change the jet type.

The problem at the base of the present invention is that of providing a sink spray head with supply jet variation and flow rate regulation, which gives the possibility to significantly simplify a structure of the means executing the jet variation.

A particular aim of the invention is that of realizing a spray head wherein the variation of the jet type can be executed very easily and naturally by the user.

Another aim of the present invention is that of realizing a spray head which, thanks to its peculiar realization characteristics, is able to give the widest guarantees of reliability and safety of use.

Another aim of the present invention is that of realizing a spray head which can be easily obtained starting from elements and materials being commonly available on sale and which, moreover, is competitive from a merely economic point of view.

### BRIEF SUMMARY OF THE INVENTION

The problem at the base of the present invention is solved by a sink spray head with supply variation and flow rate regulation, comprising a body defining at least two distinct water supply areas in communication with a distribution chamber controlled by a diverting cut-off driven by selection means accessible outside the body, a cut-off being also provided for the regulation of the water flow rate, the selection means comprising an up-and-over button.

Further characteristics and advantages will be better apparent from the description of a preferred, but nonexclusive, embodiment of a sink spray head with supply jet variation and flow rate regulation, shown by way of indicative and non-limiting example with the help of the annexed drawings.

### BRIEF DESCRIPTION OF THE SEVERAL VIEWS OF THE DRAWINGS

FIG. 1 schematically shows an elevation side view of the spray head where a possible configuration of the external shell is highlighted by a broken line;

FIG. 2 shows a front view of the spray head body;

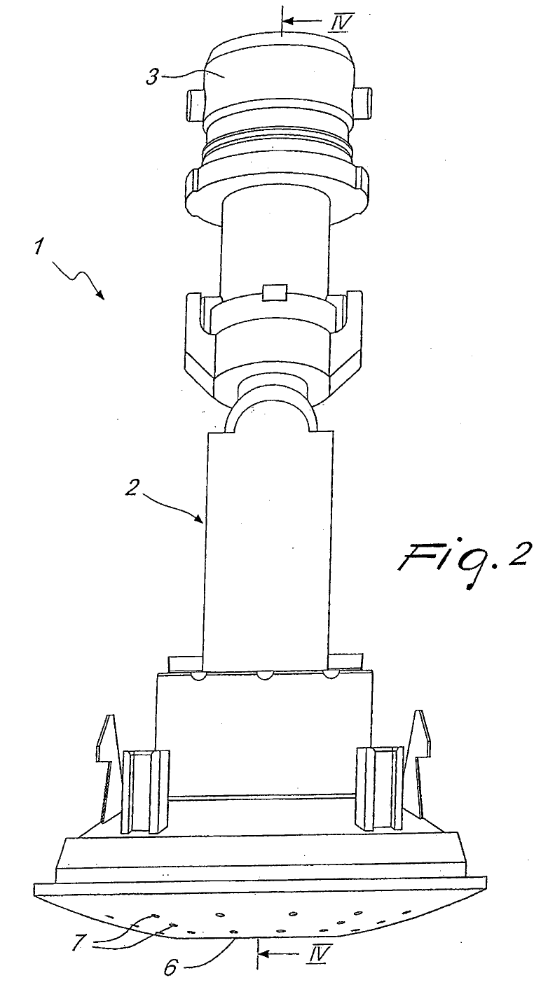

FIG. 3 shows a rear view of the spray head body;

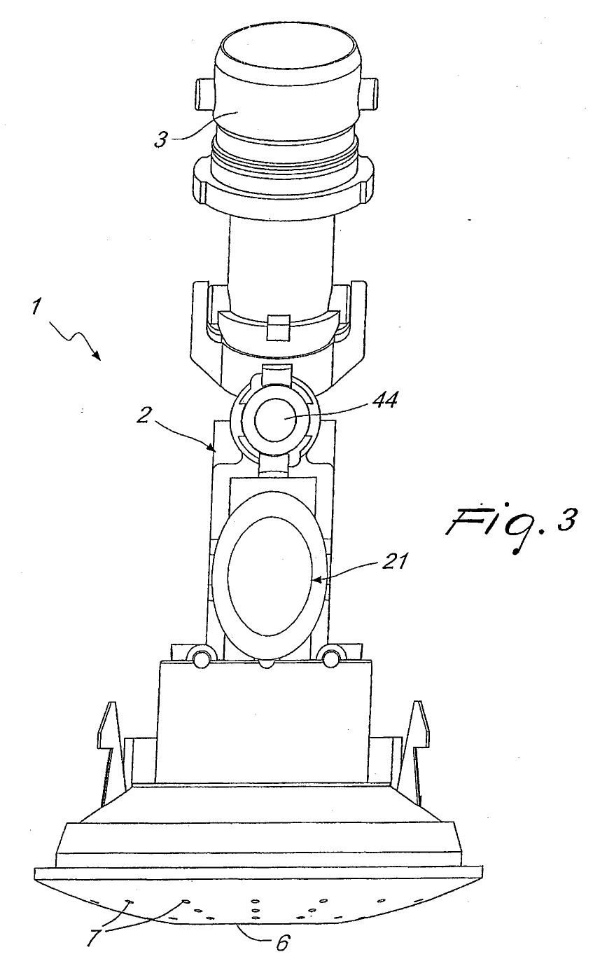

FIG. 4 shows a section along line IV-IV of FIG. 2, where the diverting cut-off is in a first position; and

FIG. 5 shows a section along line IV-IV of FIG. 2 where the diverting cut-off is in a second position, for the indiscriminate supply.

### DETAILED DESCRIPTION OF THE INVENTION A PREFERRED EMBODIMENT

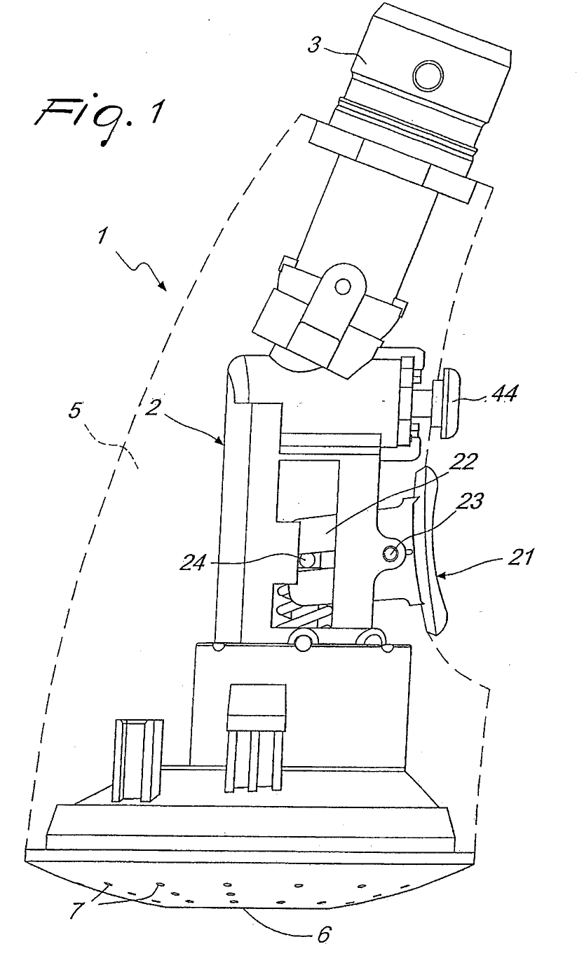

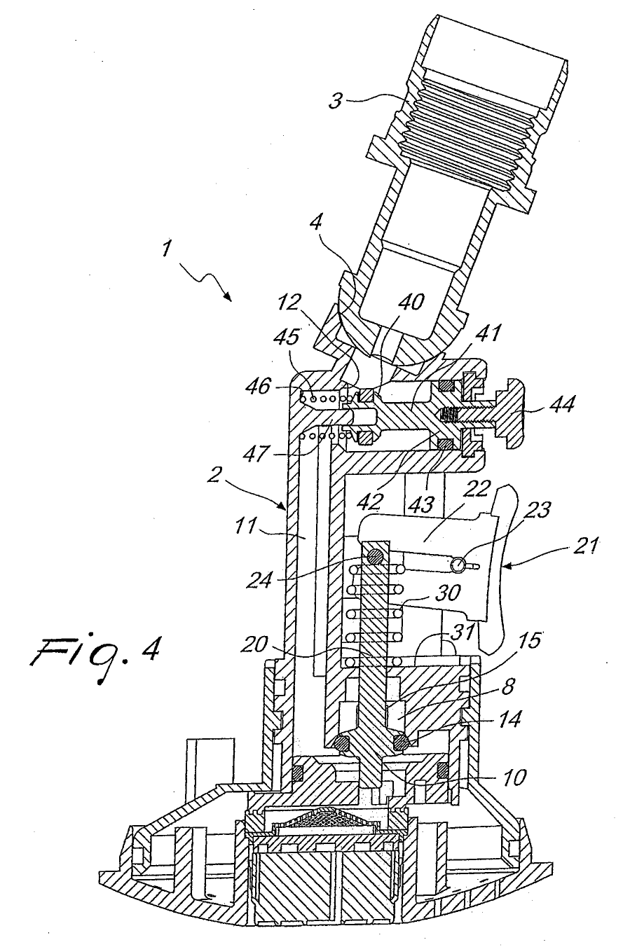

With reference to the cited figures, the sink spray head with supply jet variation and flow rate regulation, according to the invention, is indicated with reference number 1 and comprises a body 2 which is connected to a mouth 3 of connection to the water supply through a ball joint 4 (FIG. 4) which gives the possibility to obtain, with the same typology of mechanism, different configurations of the spray head, having the possibility to modify the configuration of the external shell indicated with number 5 and shown in FIG. 1 through broken lines.

The body 2 defines two distinct water supply areas which are constituted by a central area 6 for the supply of an aerated central jet and by a peripheral area 7 for the supply of an indiscriminate jet.

The areas 6 and 7 are in communication with a distribution chamber 8 wherein the diverting cut-off 10 acts, all of which will be described in detail hereafter in connection with FIG. 4.

The chamber 8 is in communication with a water delivery duct 11 which is connected to the mouth 3 through a passage port 12.

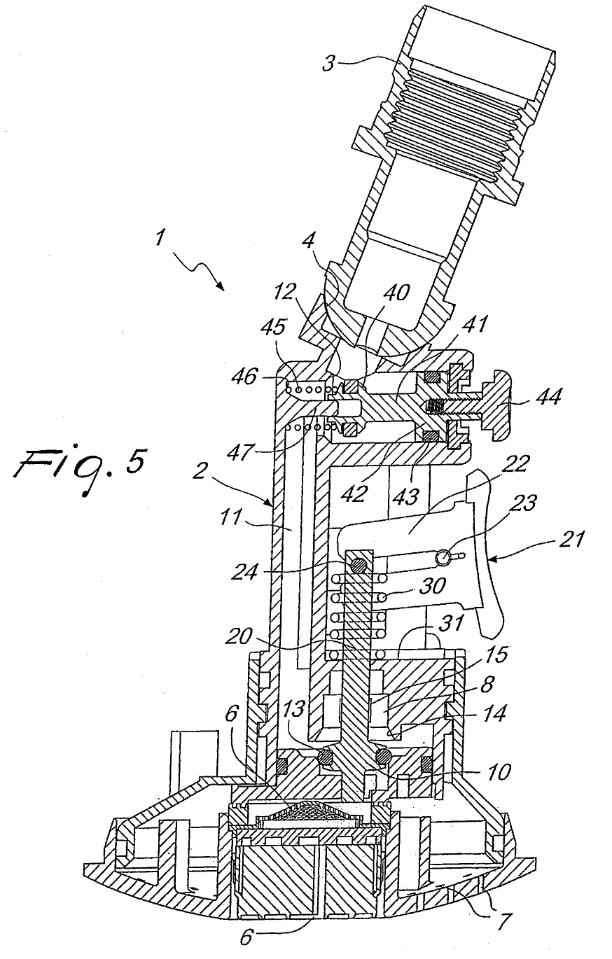

The chamber 8 defines a lower port 13 (FIG. 5), which controls the communication with the central area 6 and an upper port 14 which controls the communication with a passage hole 15 for the connection to the peripheral area 7.

The cut-off 10 is connected to a small shaft 20 slidingly guided inside the body 2.

The cut-off 10 is sliding and driven by selection means being accessible outside the body and constituted by an up-and-over button 21 which has the function of transforming the rotary motion of the button into a translation movement for the small shaft 20 and thus for said cut-off.

A fork-like body 22 is structurally associated with the button 21, the body being pivoted about a pin 23 associated with the body 2, which defines the axis of rotation for the up-and-over button 21.

The fork-like body 22 engages with a beam 24 which is placed at the free end of the small shaft 20 and which controls, in practice, the translation of the cut-off 10.

On the small shaft 20 first return elastic means act, these latter being constituted by a first spring 30 which acts between a spigot 31 of the body 2 and the beam 24 so as to bring, under rest conditions, the cut-off 10 back to close the upper port 14 for arranging the supply through the central area 6.

On the port 12 placed at the end of the water delivery duct 11 a water flow rate regulation cut-off, indicated with 40, acts, which is connected to a stem 41 associated with an expansion 42 equipped with sealing gasket 43 which is connected to an external button 44 which allows to execute the translation of the button against second elastic means constituted by a second thrust spring 45 which acts between the cut-off 40 and an abutment surface 46 of the body 2; the cut-off is slidingly guided on a stake 47.

With the above described arrangement, it is thus possible to easily pass from a supply position to the other and/or vice versa, by simply acting on the up-and-over button 21, which, through the coupling of the fork 22 to the beam 24, allows to transform the rotary motion of the button into a translation for the cut-off 10.

As per what has been shown above, it is clear how the invention attains the proposed aims and, in particular, the extreme realization simplicity and the great practicality of use derived from the presence of the up-and-over button 21 are underlined.

Moreover, the presence of the ball joint 4 allows one to untie the configuration of the spray head exterior aspect from the typology of the mechanism used, since it is possible to easily vary the external configuration although using the same inner mechanism.

The invention thus conceived can be subjected to several modifications and versions all within the inventive concept.

Moreover, all the details will have the possibility to be substituted by other technically equivalent elements.

In practice, the materials used, as well as the dimensions and the specific shapes, will be of any type according to the needs.

Advantageously, the spray head according to the present invention allows a variation of the jet type that can be executed very easily and naturally by the user.

Moreover, the spray head, thanks to its peculiar realization features, is able to give the widest guarantees of reliability and safety of use.

Least but not last the spray head can be easily obtained starting from elements and materials being commonly available on sale and which, moreover, is competitive from a merely economic point of view.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A sink spray head with supply variation and flow rate regulation, comprising a body defining at least two distinct water supply areas in communication with a distribution chamber controlled by a diverting first cut-off driven by a selection means accessible outside the body, a second cut-off being also provided for the regulation of the water flow rate, wherein the selection means comprise an up-and-over button.

2. A sink spray head according to the claim 1, wherein the up-and-over button is suitable for transforming a rotary motion of the button into a translation movement for the diverting first cut-off.

3. A sink spray head according to the claim 1, wherein the spray head comprises, associated with the up-and-over button, a fork-like body pivotable about a pin associated with the spray head body, the pin defining an axis of rotation for the up-and-over button.

4. A sink spray head according to claim 1, wherein the spray head comprises a beam extending at least substantially perpendicularly from a small shaft associated with the diverting first cut-off.

5. A sink spray head according to claim 5, wherein the spray head comprises a first return elastic means comprising a first spring acting between a spigot defined by the body and the beam for bringing the diverting first cut-off, under rest conditions, back to a predetermined supply condition.

6. A sink spray head according to claim 1, wherein spray head comprises, in the body, a delivery duct in communication with the chamber, the delivery duct defining a port controlled by the second cut-off.

7. A sink spray head according to claim 6, wherein the spray head comprises, in correspondence with the port, a guide stake slidingly engaging with the second cut-off.

8. A sink spray head according to claim 1, wherein the spray head comprises second elastic means constituted by a second thrust spring acting between the second cut-off and an abutment surface defined by the body.

9. A sink spray head according to claim 1, wherein the spray head comprises a ball joint between the body and a mouth adapted for connection to a water supply, for modifying the configuration of the external shell of the spray head.
